(19) United States
(12) Patent Application Publication
(10) Pub. No.: US 2005/0149260 A1
(43) Pub. Date: Jul. 7, 2005

(54) Method and system for communicating data in a vehicle system

(76) Inventor: Hyon S. Bae, Oakland, CA (US)

Correspondence Address: MAYER, BROWN, ROWE & MAW LLP, 190 SOUTH LASALLE ST, CHICAGO, IL, 60603-3441, US

(21) Appl. No.: 10/751,778

(22) Filed: Jan. 5, 2004

(51) Int. Cl. G01C 21/26

(52) U.S. Cl. 701/209; 701/200

(57) ABSTRACT

A method and system for communicating a location data from a portable device to an integrated navigation system in a vehicle is described. The method includes providing the portable device in communication with the integrated navigation system where the portable device has access to the location data, where the location data identifies a geographic location. The location data is then transmitted from the portable device to the integrated navigation system. A user in the vehicle communicates with the integrated navigation system to locate the location data transmitted from the portable device. Then the integrated navigation system communicates to the user the geographic location identified by the location data.

### FIELD

The present invention generally relates to automotive navigation systems, and more particularly, to an automotive navigation system that communicates with portable devices.

### BACKGROUND

With the increased popularity and widespread acceptance of Global Positioning Satellite (GPS) navigation systems in automobiles, many individuals have increased the use of these GPS systems while driving in the car and searching for unknown locations. A serious problem with these systems, however, is that a driver will take his/her attention away from the road to interact with GPS systems when needing directions to a destination.

A GPS system typically requires a driver to interact with the GPS system to provide the location that the user wishes to locate using the GPS system. That interaction typically involves one of two interaction methods: (1) a point and click method where the user must manually place a hand on the GPS system (and take the hand off of the steering wheel in order to enter data manually into a GPS system); or (2) a voice recognition system where the user must audibly say the location that the user wishes to locate using a voice recognition system that is part of the GPS system. Numerous problems exist with these systems as follows.

In the voice recognition method, the driver must provide an audible address (typically by spelling the address) to the GPS system. The problem is that the driver typically does not know the address of the location that needs to be located by the GPS system. In this situation, the driver is forced to divert his/her attention from driving to look at the address in order to audibly say the address to the GPS system. Additionally, the driver may not have the most recent address of the user and may therefore have an outdated address written in certain locations. The GPS system is therefore limited in that it only communicates with the driver audibly when the driver knows of the actually address street name.

With the point and click method, he driver must use a hand to enter an address to the GPS system. The driver creates a dangerous situation by diverting his/her attention to the point and click screen, as well as removing a hand off of the steering wheel. This situation is further worsened by the same problem with the voice recognition scenario of having to locate the most accurate address for the intended destination.

Additional problems exist for the driver in any of the current data entry methods. The level of difficulty with either the voice recognition or the point and click systems is so difficult to the extent that manufacturers of such GPS systems warn the driver not to enter data while driving. Again, it is a simple fact that the driver cannot safely drive while looking away from the road to enter alphanumeric data (point and click) or to look at addresses on written paper (both point and click or voice recognition systems). Manufacturers even go the extent of including hardware that prevents data entry unless the vehicle is completely stationary and the parking brake is engaged.

A need therefore exists for a GPS system that interacts with a driver in a safe and accurate manner to enable a driver to maintain his/her focus on the road. The GPS system also have accurately locate an intended destination without having the driver know the address of the destination, knowing only, for example, the name of the person or business being located.

### SUMMARY OF THE INVENTION

The present invention provides for a method and system for communicating a location data from a portable device to an integrated navigation system where the integrated navigation system is integrated into a vehicle. The method of the present invention includes providing the portable device in communication with the integrated navigation system. The portable device has access to the location data and the location data identifies a geographic location. The location data is then transmitted from the portable device to the integrated navigation system. After transmission, a user located within the vehicle communicates with the integrated navigation system to locate the location data that was transmitted from the portable device. Then, the integrated navigation system communicates with to the user the geographic location identified by the location data. A vehicle system for communicating location data from the portable device to integrated system is also disclosed.

### BRIEF DESCRIPTION OF THE DRAWINGS

A more complex appreciation of the invention and many of the advantages thereof will be readily obtained as the same becomes better understood by references to the detailed description when considered in connection with the accompanying drawings, wherein:

FIG. 1 is a perspective view of an embodiment of a vehicle system of the present invention;

FIG. 2 is a perspective view of an embodiment of the integrated navigation system of the present invention;

FIG. 3 is a perspective view of an embodiment of the integrated navigation system of the present invention;

FIG. 4 is a perspective view of an embodiment of both the integrated navigation system and the portable device of the present invention;

FIG. 5 is a perspective view of an embodiment of the integrated navigation system being wired to the portable device of the present invention;

FIG. 6 is a perspective view of an embodiment of the integrated navigation system being wired to a personal digital assistant of the present invention;

FIG. 7 is a perspective view of an embodiment of a portable device of the present invention in communication with a memory device;

FIG. 8 is an embodiment of a flow chart depicting a method of the present invention; and

FIG. 9 is a block diagram view of internal components of the integrated navigation system.

### DETAILED DESCRIPTION OF THE PREFERRED EMBODIMENT

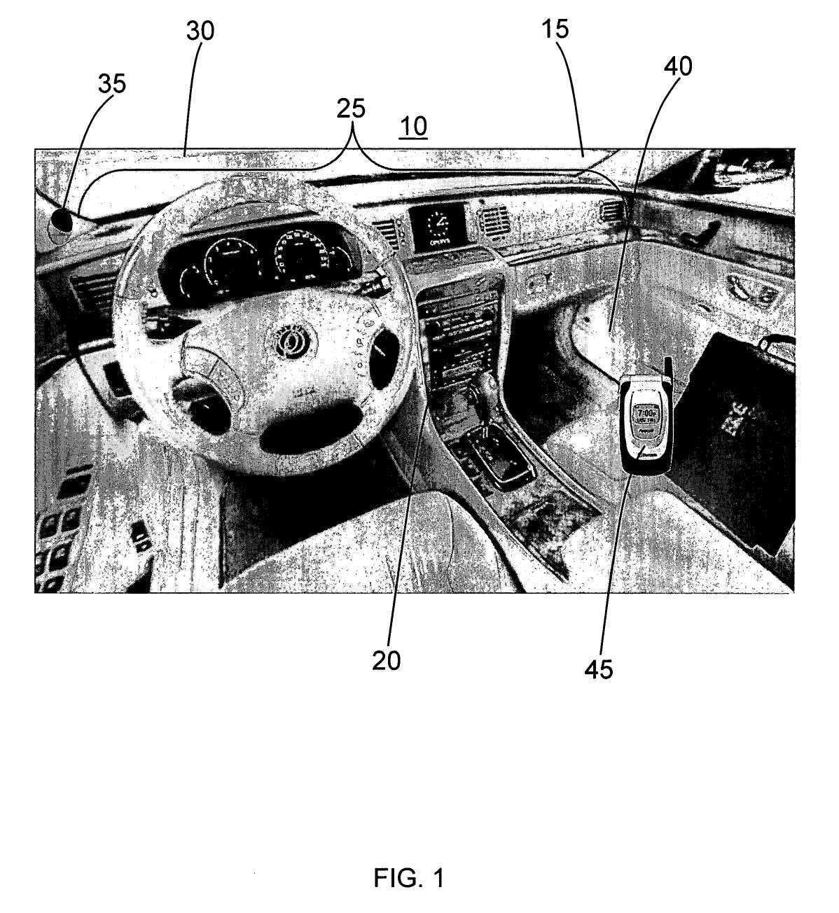

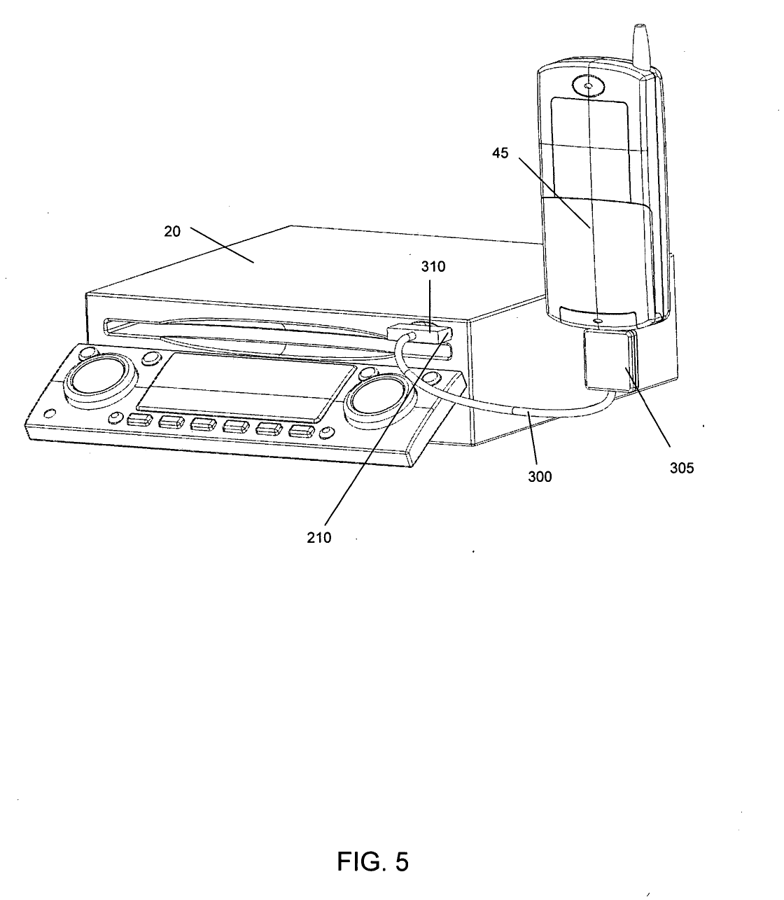

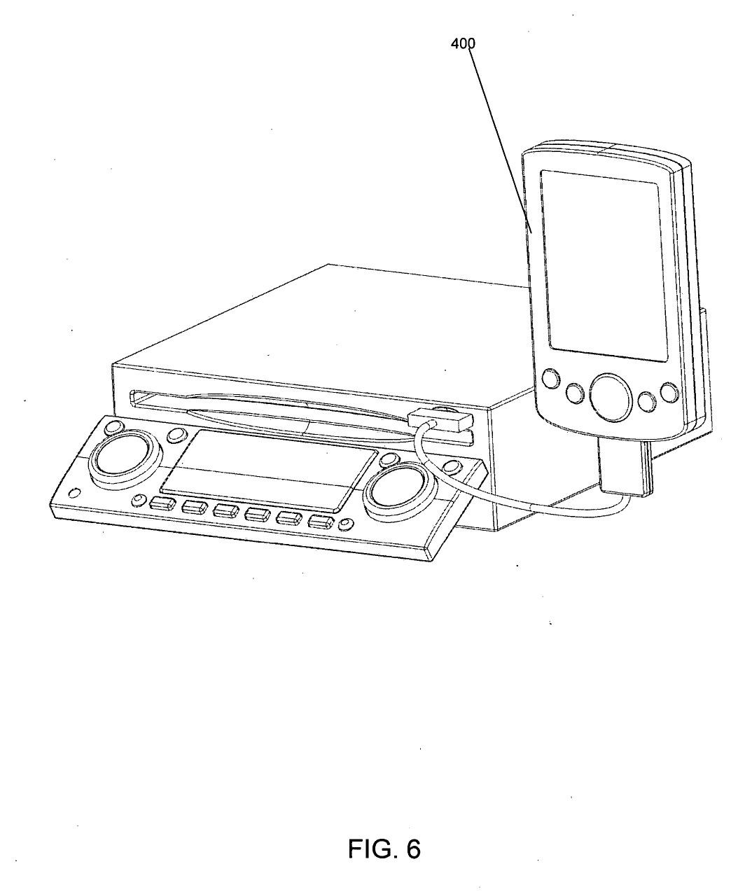

Turning now to the detailed drawings, FIG. 1 is a perspective view of an embodiment of the vehicle system of the present invention. In FIG. 1, the vehicle system 10 is shown in an embodiment of an interior of a vehicle 15. The vehicle 15, in one embodiment, is a standard automobile or car. However, in further embodiments, a vehicle may be any other standard vehicle such as a truck, a bus, a motorcycle or a van. In its broadest sense, the vehicle is any type of transport device for a driver that is intended to transport the driver between two locations. Within the vehicle 15 is an embodiment of the integrated navigation system 20 of the present invention. In this embodiment, the integrated navigation system 20 is located in the dashboard of the interior of the vehicle 15, but in alternative embodiments, the integrated navigation system 20 may be placed within the vehicle in any location so that the driver may easily and safely view the integrated navigation system 20 without being distracted from driving the vehicle 15. Thus, in alternative embodiments, the integrated vehicle system 20 may be placed throughout the dashboard 25 in any position of the dashboard 25. Alternatively, the integrated navigation system 20 may also be placed on the windshield 30 through a variety of projected displays, commonly known as “heads-up” displays. Alternatively, the integrated navigation system 20 may also be placed in a rear-view mirror, side-view mirror, or similar types of display areas that safely allow the driver to view the integrated navigation system without being distracted from driving the vehicle 15. The integrated navigation system 20 includes a microphone 25 and a speaker 40. The microphone 35 can be any integrated or attached microphone that communicates with the integrated navigation system 20 to enable audible instructions to be provided to the integrated navigation system 20 related to destinations being sought by the driver. The microphone 35 may be built into the vehicle 15 or may be attached through a hard wire (or wirelessly) to communicate with the integrated navigation system 20. Many automobiles already come equipped with microphones, or such microphones may be separately purchased for a particular integrated navigation system 20. In the embodiment of FIG. 1, the integrated navigation system 20 is shown as part of a radio device or other similar type of automobile device, in the dashboard 25. It is understood that the integrated navigation system 20 may be a part of any device in the dashboard 25 of the vehicle 15, or may be in a dashboard device of its own. The integrated navigation system 20 also includes an antenna (not shown) that is able to communicate with a Global Positioning Satellite (GPS) in order to know the exact location of the vehicle 15 throughout the world. The GPS antenna is one commonly known in the art. Also as part of the vehicle system 10, is a portable device 45, which in this embodiment, is a mobile phone. The portable device 45 may be, in other embodiments, a personal digital assistant, a cellular phone, a compact disc, a memory device or a personal computer. In essence, the portable device 45 is any device that is capable of transmitting data, either through a wire or wirelessly, to the integrated navigation system 20. That data, in one embodiment, is a location data which correlates an individual's name or other information to a location of that individual. Thus, the location data can be one or more of a city name, a zip code, a street name, a street number or a latitude and longitude coordinate that specifically identifies the location of a named individual or an entity with one or more of those location identifiers. Thus, the location data essentially identifies a person or entity with those geographic identifiers of that individual or entity. The portable device 45 communicates the location data to the integrated navigation system 20 in a number of ways. First, the integrated navigation device 20 can communicate the location data wirelessly using a number of wireless technologies that include Bluetooth® technology, wireless fidelity (Wi Fi) technology, cellular technology, infrared technology, radio frequency technology or satellite technology. The wireless communication between the portable device 45 and the integrated navigation system 20 can be accomplished in any communication manner that transmits data wirelessly through the two devices. Alternatively, the communication can also occur through wired means, including a cable or other type of wired communication between the portable device 45 and the integrated navigation system 20, as will be shown in a more detail with regard to FIGS. 5 and 6 below. It is further understood that the location data transmitted from the portable device 45 to the integrated navigation system 20 need not be locally stored on the portable device 45. Rather, the location data that is on the portable device 45 may be transmitted remotely from other locations, such as from a remote server or even the Internet, to the portable device 45 and then transmitted from that portable device 45 to the integrated navigation system 20. In one particular embodiment, the portable device 45 is able to use the Bluetooth® technology such that when a user comes within a range (e.g., a 33 feet range of the integrated navigation system 20), then the portable device 45 automatically transmits to the integrated navigation system 20 the location data using Bluetooth® technology. As commonly known, both the integrated navigation system 20 and the portable device 45, for this embodiment, require that Bluetooth® technology be enabled on both devices in order for the Bluetooth® technology transmission system to work. In alternative embodiments, not utilizing Bluetooth® technology, different adaptations to both the portable device 45 and the integrated navigation system 20 must be incorporated in those devices to transmit the location data between the two devices. So, for example, in an alternative embodiment, that uses infrared technology, both the portable device 45 and the integrated navigation system 20 must be within view of one another in order to utilize the infrared technology, as is commonly well known.

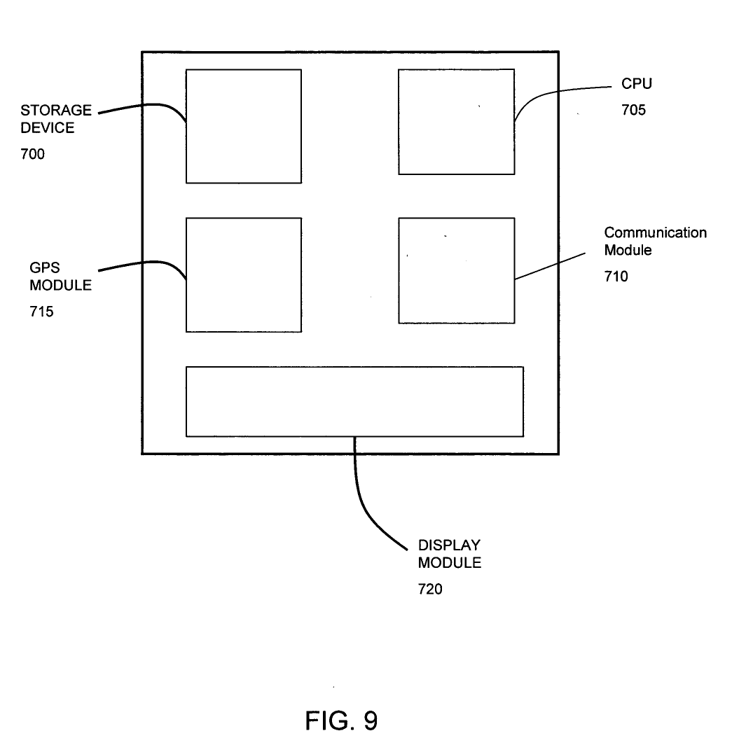

In one embodiment of the operation of the system of FIG. 1, a user (not shown) enters the vehicle 15 with the portable device 45. It is understood that the user is typically the driver of the care, however in alternative embodiments, a passenger or other person in the car may be the holder of the portable device 45 that enters the vehicle with the driver. The user, therefore, is any individual within the vehicle 15 that will communicate with the integrated navigation system 20 regardless of whether it is the driver or a passenger of the vehicle 15. It is intended that the system of the present invention be used with the driver in order to obtain the benefits of safety and non-distraction from the road that the embodiments of the present invention provide. However, it is understood that a user could be a passenger of the vehicle 15 also. Continuing on the operation of this embodiment of the invention, after the user enters the vehicle 15 with the portable device 45, the portable device 45, in one embodiment using Bluetooth® technology, automatically communicates with the integrated navigation system 20 to transmit the location data accessed by the portable device 45 directly to the integrated navigation system 20. Thus, any names and addresses (and other location data) that are accessed by the portable device 45 are being transmitted using Bluetooth® technology to the integrated navigation system 20 when the portable device enters the range of Bluetooth® technology communication between the two devices (e.g., 33 feet). At this point, the user begins operating the vehicle 15. As the user is driving the vehicle 15, the user decides that a location is needed that is unknown to the user. The user therefore begins to communicate with the integrated navigation system 20 to locate the location data that has just been transmitted from the portable device 45 to the integrated navigation system 20. It is noted that the portable device 45 may only transmit, in one embodiment, new location data that was not previously stored on the integrated navigation system 20. Thus, it is understood, that the integrated navigation system 20 contains a storage device (FIG. 9) that is able to store the location data that is transmitted from the portable device 45. FIG. 9 below shows a number of modules, including the storage device module, that is contained within the integrated navigation system 20. Continuing with the operation of the vehicle system 10, the user communicates with the integrated navigation system 20 in a number of ways to locate the location data that has been transmitted from the portable device 45. In one embodiment, the user audibly communicates with the integrated navigation system 20 through the microphone 35 and receives information from the integrated navigation system 20 through the speakers 40. In the embodiment where the user uses the microphone and speaker, the user would first turn on the integrated navigation system by speaking a start prompt such as “attention Co-Pilot.” Hearing those audible words, the integrated navigation system 20 would then respond to the user with words such as “Would you like to navigate now?” In response, the user would reply “Yes.” Then the integrated navigation system 20 would ask the user to “Please spell name.” In response, the user would spell the name Smith, letter-by-letter as follows “S-M-I-T-H”. The integrated navigation system would then respond “Did you say “did you say Smith?” At which time the user would respond “Yes.” It is understood that the integrated navigation system 20 could incorrectly find an alternative contact name, and in such case, the user could say “No”, at which time the integrated navigation system would ask the user to “Please spell the name” for a second time. It is noted that voice recognition software and systems are commonly known in the art and such a system would be used for this voice recognition system, in this embodiment. Should the name found by the integrated navigation system be correct, the integrated navigation system 20 would then retrieve the location data associated with the name “Smith” and would then map the directions to the location for “Smith” based on the location data associated with that name that was transmitted from the portable device 45. At this point, the benefit of this embodiment of the present invention is shown. While in the past, a user had to enter either through a point and click system or a voice recognition software, the address of the user, with the present invention, the user can need only say the name of the individual or entity that is being located, and the integrated navigation system is able to locate the address or other location data associated with that individual or entity in order to conveniently and easily locate the destination on a map. This system therefore increases the safety of driving so that the user need not take his/her eyes off the road in order to find an address.

Alternatively, the integrated navigation system 20 may be used to locate an address, entity or category, rather than a person. Thus, in one embodiment, the integrated navigation system 20 may ask the user for an address such as “Please spell street name.” In response, the user would then spell the name of the street and the location of the street is found based on that spelling. Alternatively, in another embodiment, the integrated navigation system may ask the user to spell an entity name, such as a business, or other institution or building that may not be a specific address. So for example, the user may ask the integrated navigation system to locate “City hall” that is spelled out for the integrated navigation system. After the integrated navigation system 20 receives the spelled “city hall”, the location is found. Alternatively, and still a further embodiment, the user may use the integrated navigation system 20 to locate a general category of businesses. For example, these categories could include, without limitation, shopping malls, restaurants, gas stations and the like. Again, the user would spell the category name, and after the category name is spelled, the location would be found of possible locations fitting that category. Thus, at this point, the integrated navigation system 20 has received, from the user, the specific location data to locate a person, address, entity or category using the integrated navigation system. Then, the integrated navigation system has provides to the user the geographic location identified by the location data. Now, the user will drive to this specific geographic location using the integrated navigation system 20. It is understood that the specific instructions or directions for locating the geographic location are provided from the integrated navigation system as verbal directions and/or visual directions on a display map. It is further noted that the integrated navigation system 20, which is incorporated as a car radio in the embodiment provided above, may be incorporated as part of a GPS system or a hands-free mobile phone system located in the vehicle.

In the embodiment above, the user communicated with the integrated navigation system 20 using a voice recognition system. It is understood that in an alternative embodiment, the user may use traditionally “point and click” technology in order to enter that same type of data to the integrated navigation system 20. While a voice recognition system may be preferable since and point and click system requires the user to remove a hand from the steering wheel and attention away from the road, it is understood that the point and click technology may be used in an embodiment of the present invention. In operation of a point and click technology, the user would follow the same example provided above for the operation of a voice recognition technology, but instead of speaking aloud the spelling of the different person, address, entity or category, the user would enter that data using alphanumeric and/or other key pad functions, such as a scroll or mouse or the like, to enter the information needed by hand rather than by voice.

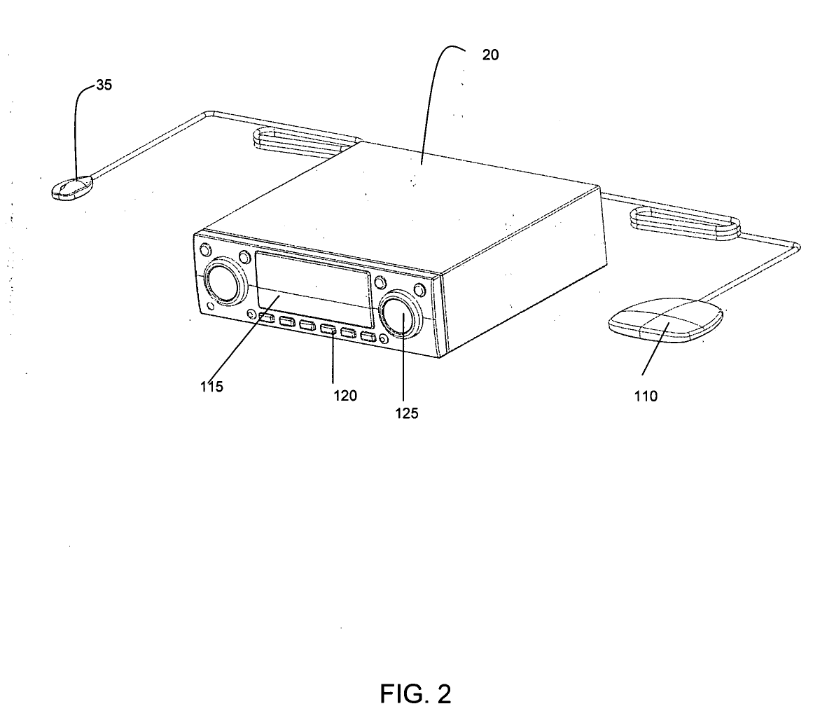

FIG. 2 is a perspective view of an embodiment of the integrated navigation system of the present invention. In FIG. 2, the integrated navigation system 20 is shown outside of a vehicle with its components, that include the microphone 35 and a GPS antenna 110 as discussed above. This embodiment shows an integrated navigation system 20 that is incorporated in a car radio type of system. It is understood that, in alternative embodiments, the integrated navigation system 20 may be incorporated in any type of GPS system or any type of hands-free system. Still in FIG. 2, the integrated navigation system 20 includes a display 115 that is able to provide visual directions or provide access to enter, using a point and click technology, information into the integrated navigation system 20. In addition, there are numerous buttons 120 and knobs 125 that further allow interaction between the user and integrated navigation system 20 in such a point and click technology. It is noted that the speakers 40, shown in FIG. 1, are not shown in FIG. 2, but such speakers would be a part of the integrated navigation system in an embodiment that required voice recognition and audible interaction with the integrated navigation system 20.

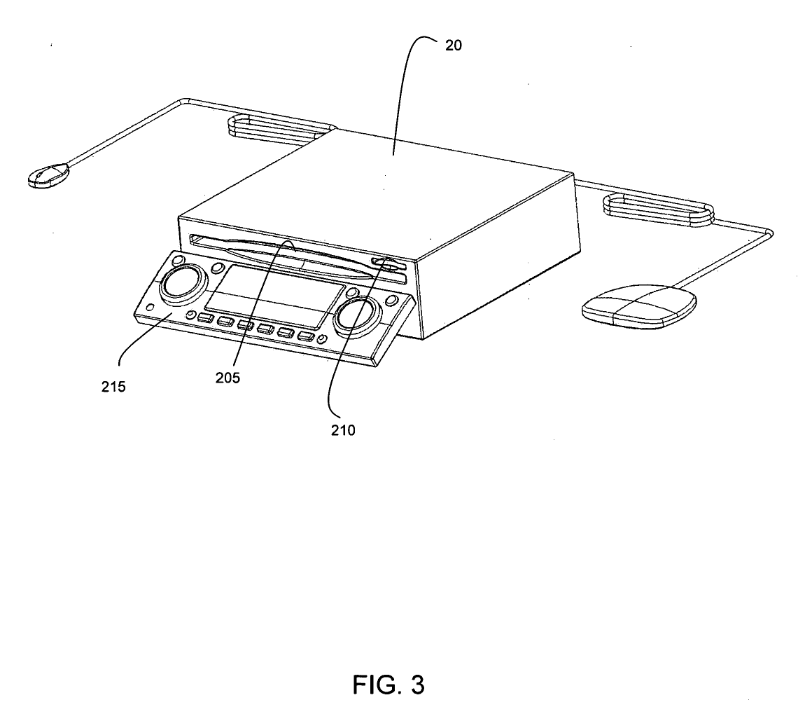

FIG. 3 is a perspective view of an embodiment of the integrated navigation system of the present invention. In FIG. 3, an alternative embodiment of the integrated navigation system 20 shows a radio type device that contains the integrated navigation system 20. However, unlike the embodiment of FIG. 2, the embodiment of FIG. 3 contains a compact disc drive 205 for entering a compact disc that contains all the names and addresses that the user would like to have access to as part of the integrated navigation system 20. Thus, while the embodiment of FIG. 1 showed a wireless transmission between a portable device 45 and the integrated navigation system 20, the embodiment of FIG. 3 shows that the same location data that was transmitted wirelessly from the portable device 45 to the integrated navigation system 20 can also be transmitted not wirelessly, but through a memory device such a the compact disc player 205. In alternative embodiments, the integrated navigation system 20 of FIG. 3 also contains a connector port 210 to make a wire connection with any portable device (not shown) in order to transfer the location data through the wire, to the integrated navigation system 20. This connector port 210 may take the form of a variety of connector ports, such as, without limitation, a compact flash slot, a USB port, a serial port, or any type of commonly known ports that are used to interface devices to transfer data. It is further noted that the embodiment of FIG. 3 displays the integrated navigation system 20 having a removable front panel 215 to access the compact disc player 205, as is well known in the art. Other embodiments may not have such a removable front panel 215, but would rather have the compact disc player 205 and connector port 210 accessible above the front panel 215.

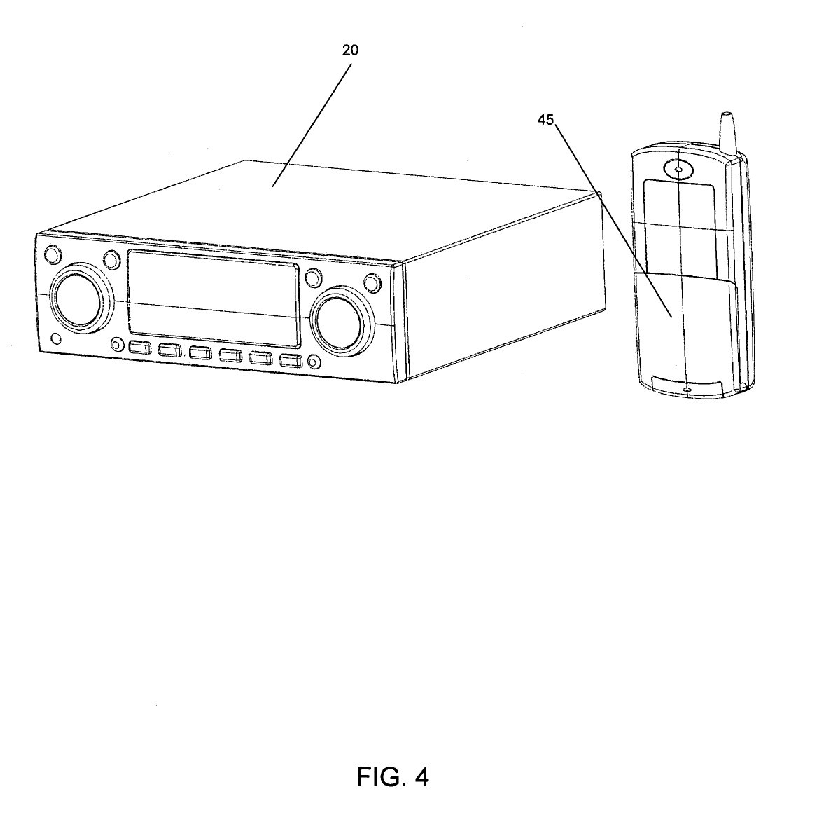

FIG. 4 is a perspective view of an embodiment of the integrated navigation system and the portable device of the present invention. As shown in the embodiment in FIG. 1, the communication between the integrated navigation system 20 and the portable device 45, shown in FIG. 4, is through a wireless transmission between the two devices. Thus, the portable device 45, shown as a mobile phone in this embodiment, is able to transmit the location data to the integrated navigation system 20 through any wireless technology, such as Bluetooth® technology, wireless fidelity (Wi Fi), cellular technology, infrared technology, radio frequency technology or satellite technology. The location data, as discussed above, refers to any data that is able to identify the geographic location of a person or entity. Thus, in a number of embodiments, the location data may take the form of a city name (e.g., San Francisco, Berkeley, Los Angeles), a zip code, a street name, a street number, or a latitude and longitude coordinate. Again, any data that identifies a geographic location may be part of a location data that is transmitted between the portable device 45 and the integrated navigation system 20.

FIG. 5 is a perspective view of an embodiment of the integrated navigation system and a portable device being connected by a wired technology. In FIG. 5, the integrated navigation system 20 is connected to the portable device 45 through a cable 300. The cable 300 may be any standard interface cable for connecting two electrical devices. As shown in FIG. 5, the portable device 45 is connected to a portable device connector 305 that enables a specific model of the portable device 45 to transmit data through the cable 300 to a second connector 310 that is able to connect to the connector port 210 of the integrated navigation system. The embodiment of FIG. 5 depicts an alternative method of transmitting the location data located in the portable device 45 to the integrated navigation system 20 using a wired technology, rather than a wireless technology. Note that in previous embodiments, a memory device can also be used, rather than a wireless technology, such as a compact disc or memory card or the like in order to transfer the location data to the integrated navigation system 20.

FIG. 6 is a perspective view of an embodiment of the integrated navigation system wired to a personal digital assistant of the present invention. In FIG. 6, an alternative embodiment of a portable device 45 is shown, depicting a personal digital assistant 400 rather, than the mobile phone depicted in prior embodiments. Note that rather than a personal digital assistant, in alternative embodiments, the portable device 45 may be a cellular phone, a compact disc, a memory device or a personal computer may be used in alternative embodiments to be wired or wirelessly connected to the integrated navigation system 20.

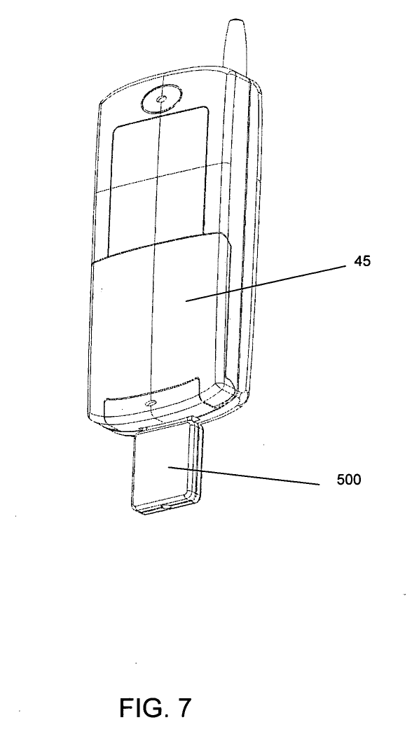

FIG. 7 is a perspective view of an embodiment of the portable device of the present invention having a memory device attached thereto. In FIG. 7, a memory device 500 is attached to the portable device 45. The memory device 500 may be used to download or otherwise transfer location data from the potable device 45 to another device, such as the integrated navigation system 20. The memory device 500 is then removed from the portable device 45 and then attached to (either through cable or directly to a port) the integrated navigation system (not shown). Thus, the location data is transferred using the memory device 500. The memory device 500 may be any type of memory, including flash, read only memory, a USB stick, compact flash memory, or similar type of portable memory.

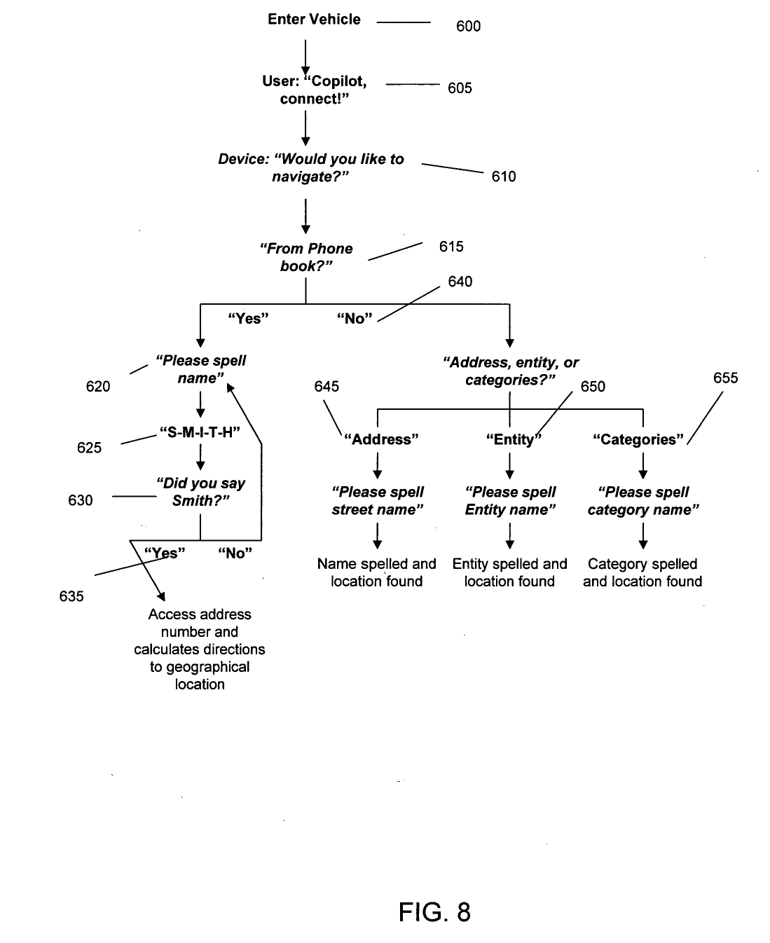

FIG. 8 is an embodiment of a flow chart depicting a method of the present invention. In FIG. 8, a user first enters a vehicle, where the vehicle has the integrated navigation system and the user carries the portable device (e.g., mobile phone) into the vehicle at step 600. Once the mobile phone is near the integrated navigation system, the mobile phone, using Bluetooth® technology in this embodiment, automatically transmits the location data, accessed by the mobile phone, to the integrated navigation system. Once in the vehicle and after the vehicle has been turned on, the user, in this embodiment, uses voice recognition to ask the integrated navigation system to turn on. Thus, at step 605, the user tells the integrated navigation system, termed “Co-Pilot” to “Co-Pilot, connect.” At this point, the integrated navigation system has been turned on using standard voice recognition systems. Next, at step 610, the integrated navigation system asks the user, through the speakers in the vehicle, if the user would like to navigate. At step 615, the user has affirmatively informed the integrated navigation system that it does wish to navigate and the integrated navigation system then asks whether the user wishes to use the phone book at step 615. If the user does want to use the phone book, at step 620, the integrated navigation system asks the user to spell the name. At step 625, the user spells the last name of the person in the phone book that the user wishes to find the geographic location of. In this example, the last name “Smith” is spelled out letter by letter. At step 630, the integrated navigation system asks the user to confirm the name “Smith.” At step 635, should the user confirm the correct name, the integrated navigation system then accesses the address of the person identified and determines the geographic location and directions to arrive at that geographic location. It is noted that, in alternative embodiments, the phone book may also contain entity addresses that the user has maintained as part of the location data that is transferred specifically to the integrated navigation system. Thus, rather than spelling the name of an individual, the user would spell the name of a restaurant or business that is also contained in the phone book. Alternatively, at step 640, the user informs the integrated navigation system that the geographic location desired is not from a personal in the phone book, but rather is a general address entity or category that the integrated navigation system may already have stored in the memory of the integrated navigation system. Thus, if there is a general address at step 645 that the user wishes to locate, the user may spell out the address for the integrated navigation system and that geographic location may be found, not from the phone book, but from stored memory in the integrated navigation system. Likewise, an entity at 650 or a category at 655 may be similarly located. By entity, it is understood that this could include any non-person address that could be a specific business or restaurant. By category, it is understood that the user is generally looking for a general type of business, such as a gas station, shopping mall, etc. Thus, the user would enter the general category, letter, by letter to the integrated navigation system to locate all entities within that category stored by the integrated navigation system.

FIG. 9 is a block diagram view of internal components of the integrated navigation system. In FIG. 9, a storage device 700 is shown that could contain all data, including location data or previously stored data, in the integrated navigation system. This storage device may take the form of any well known memory including, without limitation, random access memory, flash memory, hard disc drives, or any other type of memory that stores data. Also, in FIG. 9, is a CPU 705 that controls the flow of communication in between modules of the integrated navigation system 20 and controls transmission of information to and from the integrated navigation system. Still in FIG. 9, a communication module 710 is used to transmit and receive data to and from the integrated navigation system 20. GPS module 715 is used to communicate data between the GPS antenna (not shown) and ultimately a satellite between the integrated navigation system 20 and the satellite. These modules all contained electronics and devices that are commonly known and used to transmit and receive the data related to those modules. Also, in FIG. 9, is the display module 720 that contains all electronics and devices necessary to display the map for the point and click technology needed by the user to interface with the integrated navigation system.

It will be understood that the above-described apparatus and the method therefrom are merely illustrative of applications of the principles of this invention and many other embodiments and modifications may be made without departing from the spirit and scope of the invention as defined in the claims.

1. A method for communicating a location data from a portable device to an integrated navigation system, the integrated navigation system being integrated in a vehicle, comprising:
providing the portable device in communication with the integrated navigation system, the portable device having access to the location data, the location data identifying a geographic location;
transmitting the location data from the portable device to the integrated navigation system;
communicating, by a user within the vehicle, with the integrated navigation system to locate the location data transmitted from the portable device;
communicating, by the integrated navigation system to the user, the geographic location identified by the location data.

2. The method of claim 1, further comprising:
driving, after communicating the geographic location by the integrated navigation system, to the geographic location.

3. The method of claim 1, wherein the step of communicating by the integrated navigation system further comprises:
communicating, to the user, verbal directions for locating the geographic location.

4. The method of claim 1, wherein the step of communicating by the integrated navigation system further comprises:
communicating, to the user, visual directions for locating the geographic location.

5. The method of claim 1, wherein the integrated navigation system is mounted in the dashboard of the vehicle.

6. The method of claim 1, wherein the location data is one or more of a city name, a zip code, a street name, a street number or a latitude and longitude coordinate.

7. The method of claim 1, wherein the mobile device is one or more of a mobile phone, a personal digital assistant, a cellular phone, a compact disc, a memory device or a personal computer.

8. The method of claim 1, wherein the step of providing the portable device further comprises:
accessing the location data from a remote location outside of the vehicle.

9. The method of claim 8, wherein the remote location is one or more of a remote server or the Internet.

10. The method of claim 1, wherein the vehicle is one of an automobile, a truck, a bus, a motorcycle or a van.

11. The method of claim 1, wherein the integrated navigation system is integrated into one of a car radio, a global positioning system or a hands-free system.

12. The method of claim 1, wherein the transmitting step further comprises:
transmitting the location data from the portable device to the integrated navigation system using a wireless technology.

13. The method of claim 12, wherein the wireless technology is one of a Bluetooth® technology, a wireless fidelity, a cellular technology, an infrared technology, a radio frequency technology or a satellite technology.

14. The method of claim 1, wherein the transmitting step further comprises:
transmitting the location data from the portable device to the integrated navigation system using one of a wire or a memory device.

15. The method of claim 1, wherein the step of communicating by the user with the integrated navigation system further comprises:
communicating, by the user within the vehicle, with the integrated navigation system using one of a point and click technology or a voice recognition technology.

16. A vehicle system for communicating a location data from a portable device to an integrated navigation system, the integrated navigation system being integrated in a vehicle, comprising:
the portable device being in communication with the integrated navigation system, the portable device having access to the location data, the location data identifying a geographic location; and
the integrated navigation system for receiving the location data from the portable device and communicating with a user within the vehicle to retrieve the geographic location identified with the location data received from the portable device.

17. The vehicle system of claim 16, wherein the integrated navigation system is mounted in the dashboard of the vehicle.

18. The vehicle system of claim 16, wherein the location data is one or more of a city name, a zip code, a street name, a street number or a latitude and longitude coordinate.

19. The vehicle system of claim 16, wherein the mobile device is one or more of a mobile phone, a personal digital assistant, a cellular phone, a compact disc, a memory device or a personal computer.

20. The vehicle system of claim 16, wherein the vehicle is one of an automobile, a truck, a bus, a motorcycle or a van.

21. The vehicle system of claim 16, wherein the integrated navigation system is integrated into one of a car radio, a global positioning system or a hands-free system.

22. The vehicle system of claim 16, wherein the integrated navigation system uses a wireless technology to communicate with the user, the wireless technology being one of a Bluetooth® technology, a wireless fidelity, a cellular technology, an infrared technology, a radio frequency technology or a satellite technology.

23. A vehicle system for communicating a location data from a portable device to an integrated navigation system, the integrated navigation system being integrated within the dashboard of a vehicle, comprising:
the portable device being in communication with the integrated navigation system, the portable device having access to the location data, the location data identifying a geographic location; and
the integrated navigation system for receiving the location data from the portable device and communicating with a user within the vehicle to retrieve the geographic location identified with the location data received from the portable device.
